(19) United States
(12) Patent Application Publication
(10) Pub. No.: US 2016/0125294 A1
(43) Pub. Date: May 5, 2016

(54) METHOD FOR FORECASTING ENERGY DEMANDS THAT INCORPORATES URBAN HEAT ISLAND

(71) Applicant: Research Foundation of the City University of New York, New York, NY (US)

(72) Inventors: Jorge E. Gonzalez, Baldwin, NY (US); Mark Arend, Little Silver, NJ (US); Estatio Gutierrez, New York, NY (US); Thomas Legbandt, New York, NY (US); Fred Moshary, New York, NY (US)

(21) Appl. No.: 14/530,099

(22) Filed: Oct. 31, 2014

(51) Int. Cl. G06N 5/04

(52) U.S. Cl. CPC G06N 5/04

(57) ABSTRACT

A method for forecasting energy demand for a single building, a neighborhood or a city in an urban environment is disclosed. The method treats urban heat island (UHI) calculations as being dynamically impacted by predicted weather conditions to calculate a weather-adjusted UHI. Predicted energy consumption rates for weather conditions use the weather-adjusted UHI to increase accuracy of the prediction.

### STATEMENT OF FEDERALLY SPONSORED RESEARCH OR DEVELOPMENT

This invention was made with Government support under Contract Number NA060AR4810162 awarded by the National Oceanic and Atmospheric Agency and Contract Number 0933414 awarded by the National Science Foundation.

### BACKGROUND OF THE INVENTION

The subject matter disclosed herein relates to methods of forecasting energy consumption of building(s) in an urban environment. The forecasting of energy demands for buildings is currently based on historical records of energy demands for given locations. These locations may include electrical sub-stations, single buildings, or blocks of buildings. A variety of utility companies use this approach to prepare a power grid and the corresponding energy production, particularly in peak demand conditions. This approach has not proven entirely satisfactory as actual demand often does not correspond with the predicted demand. The gap is particular pronounced during extreme weather (e.g. heat waves) in urban centers with a dense population. An improved method of forecasting energy demands is therefore desired.

The discussion above is merely provided for general background information and is not intended to be used as an aid in determining the scope of the claimed subject matter.

### BRIEF DESCRIPTION OF THE INVENTION

A method for forecasting energy consumption for a single building, a neighborhood or a city in an urban environment is disclosed. The method treats urban heat island (UHI) calculations as being dynamically impacted by predicted weather conditions to calculate a weather-adjusted UHI. Predicted energy consumption rates for weather conditions use the weather-adjusted UHI to increase accuracy of the prediction. An advantage that may be realized in the practice of some disclosed embodiments of the method is that more accurate forecasts of energy consumption can be made for urban environments.

In a first embodiment, a method for forecasting energy demand for at least one building in an urban environment is provided. The method comprises determining a predicted weather condition of an urban environment at a predetermined time using a weather forecasting model; finding, using a building energy model, an impact of the predicted weather condition on an urban heat island (UHI) of the urban environment, the step of finding producing a weather-adjusted UHI condition; and quantifying a predicted energy consumption rate for a building in the urban environment at the predetermined time based on the weather-adjusted UHI condition that incorporates the impact of the predicted weather condition on the urban heat island (UHI).

In a second embodiment, a method for forecasting energy demand for a plurality of building in an urban environment is provided. The method comprises determining a predicted weather condition of an urban environment at a predetermined time using a weather forecasting model; modifying the predicted weather condition using a building energy model that incorporates an impact of an urban heat island (UHI) of the urban environment on the predicted weather condition, the step of modifying producing a predicted local condition; wherein the building energy model segments the urban environment into uniform grids wherein at least 20% of buildings within at least one uniform grid have a height greater than ten meters; and quantifying a predicted energy consumption rate for a plurality of buildings in the urban environment at the predetermined time based on the predicted local condition that incorporates the impact of the urban heat island (UHI) on the predicted weather condition.

In a third embodiment, a method for forecasting energy demand for a plurality of building in an urban environment is provided. The method comprises determining a predicted weather condition of an urban environment over a predetermined time frame using a weather forecasting model; modifying the predicted weather condition using a building energy model that incorporates an impact of an urban heat island (UHI) of the urban environment on the predicted weather condition, the step of modifying producing a predicted local condition; wherein the building energy model segments the urban environment into uniform grids wherein at least 20% of buildings within at least one uniform grid have a height greater than ten meters; and quantifying a predicted energy consumption rate for a plurality of buildings in the urban environment over the predetermined time frame based on the predicted local condition that incorporates the impact of the urban heat island (UHI) on the predicted weather condition.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is an exemplary output from one disclosed method wherein power consumption rate of air conditioners (AC) is shown for New York City (NYC);

FIG. 2 is a schematic depiction of Building Energy Parameterization (BEP) and a Building Energy Model (BEM) for an exemplary urban area;

FIG. 3 depicts surface temperatures from NYCMetNet observations on Jul. 6, 2010 at 1400 ET;

FIG. 4 depicts surface temperature from NYCMetNet observations as a function of time from Jul. 5, 2010 to Jul. 7, 2010;

FIG. 5 shows building height in meters while FIG. 6 shows change in building height in meters;

FIG. 7 shows national data land cover dataset while FIG. 8 shows corrected data land cover dataset;

FIG. 9 shows surface temperature simulations using an urban morphological approach while FIG. 10 shows surface temperature simulations using a grid approach;

FIG. 11 shows root mean square error (RMSE) using an urban morphological approach while FIG. 12 shows RMSE using a grid approach;

FIG. 13 shows surface temperature simulations on Jul. 6, 2010 at 15:00 ET for buildings with dark roofs while FIG. 14 shows surface temperature simulations for the same time for white roofs;

FIG. 15 shows dark roof and white roof hourly surface temperature simulations on Jul. 6, 2010 for a location in Midtown Manhattan;

FIG. 16 shows dark roof and white roof hourly power consumption for ACs on Jul. 6, 2010 for the location in Midtown Manhattan; and

FIG. 17 shows dark roof hourly power consumption for ACs on Jul. 6, 2010 for an urban area, and FIG. 18 shows white roof hourly power consumption for the urban area.

### DETAILED DESCRIPTION OF THE INVENTION

The disclosed method forecasts energy demands for buildings within a domain (block, city, region), under a predicted weather event; past, present or future. The disclosed method uses existing high resolution weather prediction models coupled to building energy models to forecast energy demands of buildings within cities and for the entire city. The disclosed approach accommodates for weather fluctuations that deviate from long-term norms, and/or spatial characteristics of the neighborhood and or city by considering real time temporal fluctuations of local weather and specific characteristics of buildings, neighborhoods, and cities, including; building heights, materials, optical properties, HVAC and energy generation systems used, and usage by occupants. The forecasting of energy demands for neighborhoods and cities has a wide range of potential applications for; a) utility companies to anticipate demands on their electrical and gas grids, b) for building managers to anticipate operation of energy production and heating, ventilating, and air conditioning (HVAC) equipment, c) for data centers to optimize their operation, d) for carbon market businesses to anticipate stocks, e) for renewable energy technologies to anticipate production, and f) for urban/building planners, among many other potential users.

The method uses an existing weather forecasting model, such as the Weather Research and Forecasting (WRF) mesoscale model, that is coupled to a building energy model. The building energy model considers thermal and mechanical effects of an urban environment including a building scale energy model to account for anthropogenic heat contributions due to indoor-outdoor temperature differences. Building electrical consumption from commercial and residential buildings during the summer is mostly associated with the use of air conditioning to maintain indoor human comfort conditions. The building energy model uses three-dimensional (3D) building characteristics, geo-spatially organized into uniform grids representing a neighborhood or a city that is initialized by traditional weather forecasting data such as North American Mesoscale (NAM) output or equivalent.

The method is particularly useful in urban environments where urban heat islands are particularly pronounced. In one embodiment, the urban environment is segments into grids wherein at least one grid has at least 20% of the buildings with a height of at least ten meters. In another embodiment, at least one grid in the urban environment has at least 40% of the buildings with a height of at least ten meters.

In one embodiment, an energy forecasting tool is provided that comprises a software application tangibly embodied in a non-transient computer-readable storage medium. The energy forecasting tool comprises a) a weather forecasting modeling coupled to a building energy model, b) a building data set for a specific location for use by the building energy model, c) four-dimensional (4D) initial and boundary conditions, and d) an efficient computing hardware system to execute forecasting. Typical computer resources with 2014 technology use more than 100 processors operating in parallel and several terabytes (TB) of storage.

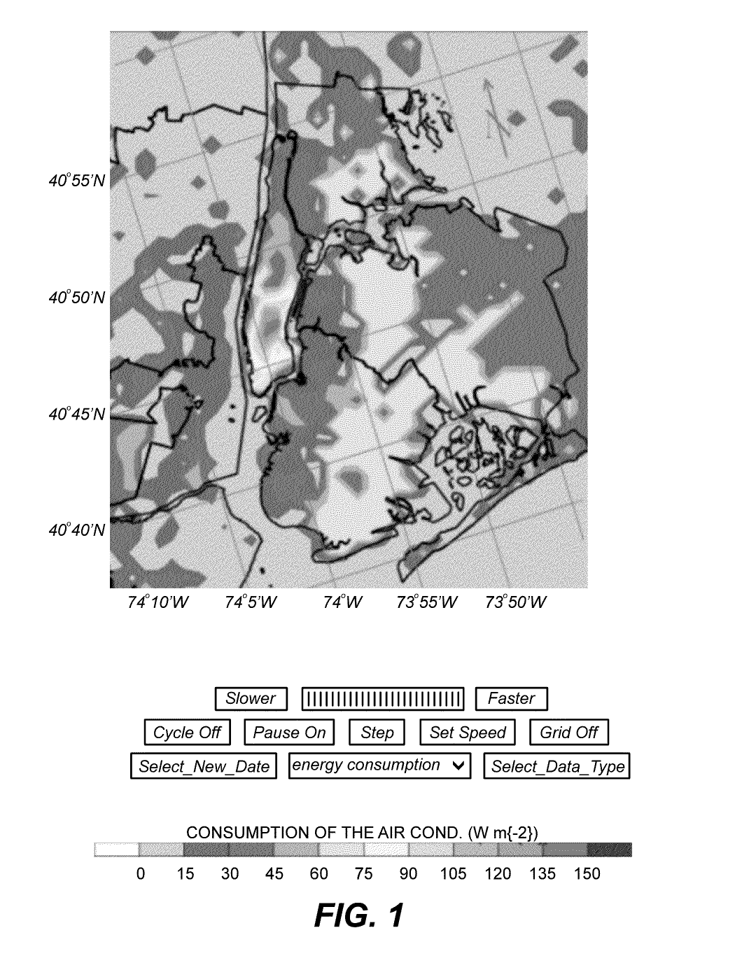

The output of the disclosed method includes; typical weather data (wind, temperature, humidity, etc.) and energy demands for each building grid (in W/m² or kWh) or for an entire neighborhood or city, as a function of weather conditions and usage of the building. The information is provided at temporal resolutions that can vary from minutes to days, and spatial resolutions can vary from a few meters to a few kilometers, in two-dimensions (2D) or three-dimensions (3D). An example of the output is shown in FIG. 1, where energy is being forecasted for Aug. 21, 2013 for the entire New York City.

In an exemplary embodiment, the disclosed method is used to evaluate a resulting urban heat island (UHI) formation associated to a multi-day (e.g. three-day) heat wave in a metropolitan area (e.g. New York City (NYC)) over a predetermined time period (e.g. during the summer of 2010).

As a comparative example, a series of simulations were conducted with both a single building energy model (SBEM), such as the U.S. Department of energy EQUEST™ and ENERGYPLUS™ and an urbanized weather forecasting model (uWRF). ENERGYPLUS™ is a tool developed by the U.S. Department of Energy for analyzing energy dynamics of single buildings and is useful for designing and sizing HVAC equipment. Such SBEM systems account for direct, diffuse and reflected solar radiation, longwave thermal radiation from the environment, convective exchange with air, conductive heat flux into walls, radiation from internal sources (e.g. computers, lights, office equipment, etc.) and radiation from other zones. Some SBEM tools also incorporate the effects of shadows created by surfaces of the building due to the changing position of the sun. Building energy consumption due to air conditioner use was modeled at an Uptown location (coordinates 40.822631, −73.951367) and a Midtown location (coordinates 40.759302, −73.969148) in Manhattan which represented a low density and a high density building area. The modeling was conducted using SBEM driven by Typical Meteorlogical Year (TMY) weather file. The SBEM model showed the uptown location consumed 137% more energy during a Jul. 4-8, 2010 heat wave while the Midtown location consumed 125% more energy compared to a typically July three-day period. The urban heat island (UHT) during this period was recorded at a maximum of 4° C. in the night and at 2° C. during the hottest day. In comparison to energy consumption modeled using the disclosed method, the SBEM model underestimated total energy consumption within a factor of three. Without wishing to be bound to any particular theory, it is believed the SBEM fails to take into account urban heat island (UHI) effects such as anthropogenic sources and waste heat interactions between surrounding buildings. SBEM models are primarily driven by TMY weather files and do not account for UHI.

In this example, a historical time period is selected for demonstration purposes but the method is equally applicable to future time periods. High-resolution (250 m) urban canopy parameters (UCPs) from the National Urban Database were employed to initialize the multilayer urban parameterization. The precision of the numerical simulations was evaluated using a range of observations. Data from a dense network of surface weather stations, wind profilers, and Lidar measurements are compared to model outputs over Manhattan and its surroundings during the 3-days event. Thermal and drag effects of buildings represented in the multilayer urban canopy model improves simulations over urban regions giving better estimates of the 2 m surface air temperature and 10 m wind speed. An accurate representation of the nocturnal urban heat island registered over NYC in the event was obtained from the improved method. The accuracy of the method was further assessed against more simplified urban parameterizations models with positive results. The method was also used to quantify the energy consumption of the buildings during the heat wave, and to explore alternatives to mitigate the intensity of the UHI during the heat wave.

The UHI has a substantial impact on meteorological conditions of urbanized regions. The main contributing factors to temperature differences between urban and rural environment are changes in physical characteristics of surface such as albedo, thermal capacity and heat conductivity due to the replacement of vegetation by asphalt and concrete; decrease of surface moisture available for evapotranspiration; changes in radiative fluxes and in the near-surface flow due to the complicated geometry of streets and tall buildings, and anthropogenic heat. The UHI circulation associated with an urban area can significantly alter lower tropospheric winds and low-level pollutant dispersion. UHI formation occurs when urban structures store solar energy during the daytime. This energy is released as sensible heat at nighttime while the heat flux to the ground in rural areas produce a decrease on the surface temperatures in urban surroundings. The UHI increases during the afternoon to reach a maximum during the night and decreasing after dawn. UHI could has significant impacts on air quality and energy demands. Reports for the city of Los Angeles show an energy demand impact of 500 MW per ° C. of UHI increase. These estimates are based on historical records of UHI trends and energy.

UHI magnitude depends on local conditions like wind speed and cloud cover. High wind speeds reduce the UHI through the ventilation of the urban area while clouds diminish the negative heat flux over rural regions. Urban-rural temperature difference is greatest on clear nights with low humidity through-out the troposphere and gentle northwest winds. The urban-rural temperature difference is strongly reduced by sea breezes and backdoor cold fronts during spring and summer. In the NYC area, wind speed has strongly declined over the century due to the increase of building heights intensifying the UHI. The UHI spatial extent also depends on many spatial variables, such as surface moisture and vegetation cover, in addition to those listed above. Without out wishing to be bound to any particular theory, this is believed to be an indication that the UHI should be viewed as a dynamic meteorological phenomenon and not as a constant, uniform feature.

Urban effects in mesoscale models have been represented using different techniques and parameterizations. The disclosed method takes into account the impact of a city on the momentum, turbulence, and the heat exchanges. The first approach to modify the dynamics in the models was increasing roughness over urban areas assuming that turbulent fluxes were constant with height. Most of the mesoscale models use this method to represent flow dynamics over cities. The urban surface exchange parameterization incorporated into the latest version of WRF employs a very high vertical resolution with several layers within the urban canopy where a sink term is introduced in the momentum equation to represent the drag induced by the buildings.

The reduction of the total albedo and the nocturnal radiation loss caused by the buildings is parameterized through the calculation of the energy budget for walls and streets where the street directions and wind speed in the canopy are important factors. The shadowing and radiation trapping effects constitute important components of the surface energy balance. In this example, the WRF model is coupled with a multilayer urban layer urban parameterization to simulate the evolution of the surface temperature during a heat wave over New York City and the energy consumption associated to this heat wave by the city. The energy consumption and heat release response during an extreme heat event and possible mitigation alternatives were also determined.

### Model Configuration

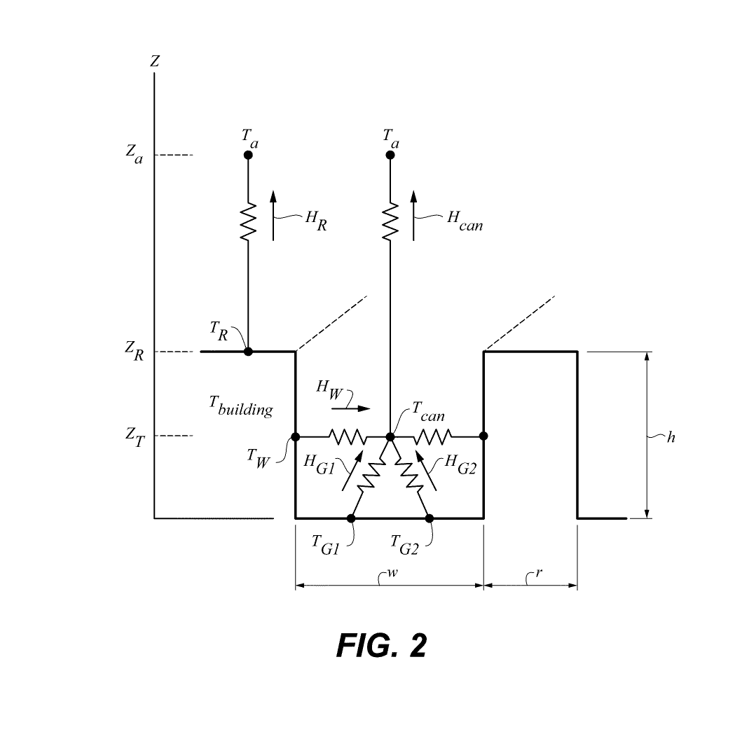

The mesoscale WRF model, coupled to a multilayer urban parameterization, is used to simulate the evolution of surface temperature and energy consumption and associated heat release to the environment during a heat wave event over New York City from Jul. 4-8, 2010. The new urban model incorporated from WRF version 3.2 comprises a Building Energy Parameterization (BEP) and a Building Energy Model (BEM). BEP accounts for impacts from horizontal and vertical building surfaces in the momentum, heat, and turbulent kinetic energy equations. BEM, for each building floor (FIG. 2), considers the diffusion of heat through walls, roofs and floor; natural ventilation; radiation exchange between indoor surfaces; generations of heat due to occupants and equipments and the consumption due to air conditioning (AC) systems. Both BEP and BEM work together to predict urban weather and energy consumption. The buildings in the exemplary model were assigned a square shape, an area of 625 square meters, three floors, a street width of 25 meters, a building width of 20 meters, an urban fraction of 1, a DX cooling coil as a cooling system, a heat capacity of 1.32 MJ 111⁻³ K⁻¹ (e.g. concrete) and thermal conductivity equal to 0.6 J m⁻¹ s⁻¹ K⁻¹. Windows have a coverage fraction of 0.2, an isolation transmittance of 0.3 and a surface window coefficient of 2.8 W K⁻¹ m⁻². The coefficient of performance of the AC system was set to 2.8 with a heat exchanger thermal efficiency of 0.75. An equipment gain of 36 w per square meter was set. Additional energy parameters are available from local building codes. These building parameters can be adjusted to better represent individual buildings within the grid or for entire cities.

Four two-way nested domains were constructed with spatial grid resolution of 9, 3, 1, and 0.333 km which contained 70×70, 61×61, 61×61, and 100×100 grid boxes, respectively, from west to east and north to south. Fifty one terrain following sigma levels were defined with twenty levels in the first kilometer. The Bougeault-Lacarrere (BouLac) planetary boundary layer scheme was adopted. This turbulent kinetic energy prediction option was designed for use with BEP/BEM urban models. The Single Moment 3-class and Kain-Fritsch scheme were the microphysics and cumulus options selected. The cumulus parameterization was only applied to the course domain and the first nest. The initial and boundary conditions for WRF were obtained from the North American Mesoscale (NAM) data sets with 12 km resolution at 3 h intervals. NCEP/MMAB data at 0.5 deg were employed to update the sea surface temperature every 24 h.

### Data Sources

In addition to surface and meteorological initial and boundary conditions, the urbanized mesoscale model uses an extra set of specific input parameters that describe the complex arrangement of buildings and streets on an urban environment. The general approach is to represent the city in a simpler way where all the buildings within the grid cell have the same horizontal distribution and are located at the same distance from each other. The WRF model uses data from the National Building Statistics Database (NBSD2), developed at Los Alamos National Laboratory, that has a set of thirteen building statistics computed at 250 m spatial resolution from three-dimensional digital building data for several metropolitan areas in the USA. The buildings statistics included in NBSD2 are mean building height, height histograms, plan area fraction, height to width ratio, sky factor among others. For New York, NBSD2 data are available for Manhattan, part of the boroughs and New Jersey next to the East and Hudson rivers, respectively. The grid size may be selected to group buildings with one or more uniform building statistics together. As used in this specification, the term uniform generally refers to a grid wherein at least 40% of the buildings are within 10% for the measured parameter. For example, a grid with uniform height has at least 40% of the buildings within 10% of the average height of the buildings within the grid. The current version of the model uses New York City Building Tax Lot Data which reduced uncertainties for the building distribution across the City. Similar approaches to represent the buildings can be used for other cities worldwide.

The NYCMetNet is a permanent meteorological observing network for the greater NYC metro area that brings together a number of regional observing networks. In this example, thirty-six surface stations from the Citizen Weather Observer Program, Earth Networks, Inc., Weatherflow, Inc., Automated Surface Observing Systems and the Remote Automated Weather Stations were used to validate the model simulations with the urban parameterization.

### Heat Wave Sinoptic Pattern

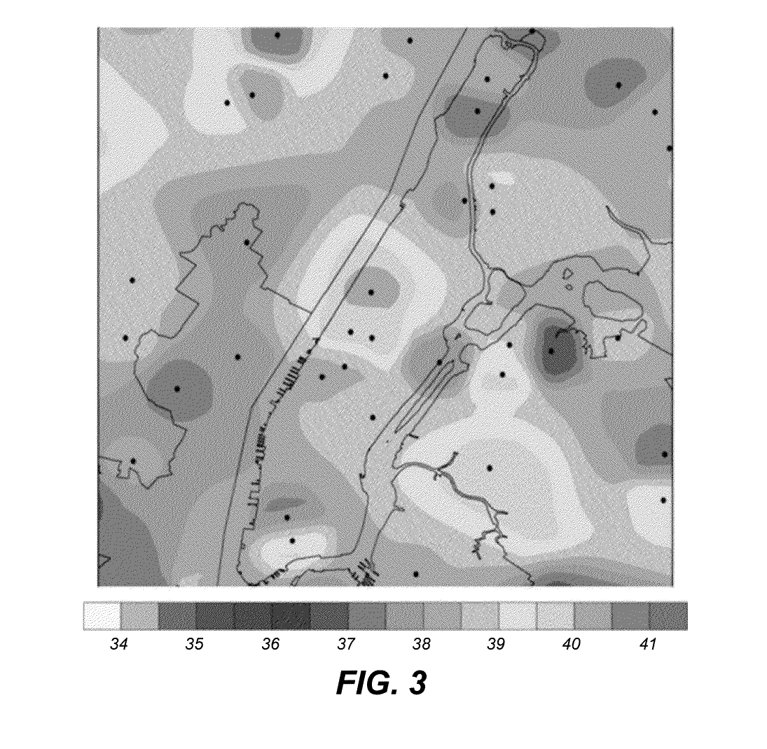

A heat wave affected the east coast from Jul. 4-8, 2010 with maximum surface temperatures that exceeded 32° C. (90° F.). The large scale conditions associated with the heat wave included a strong subtropical ridge at 500 hPa, an intense surface high, weak west-northwesterly flow, and deep warm air from the surface to 700 hPa. Warm air from the plains was moved eastward by the subtropical ridge bringing high temperatures to the east coast. NYCMetNet data show temperatures on July 6 at 1500 ET reaching values around 38° C. (100° F.) all over New York City and 40° C. (104° F.) in some parts of Manhattan. See FIG. 3.

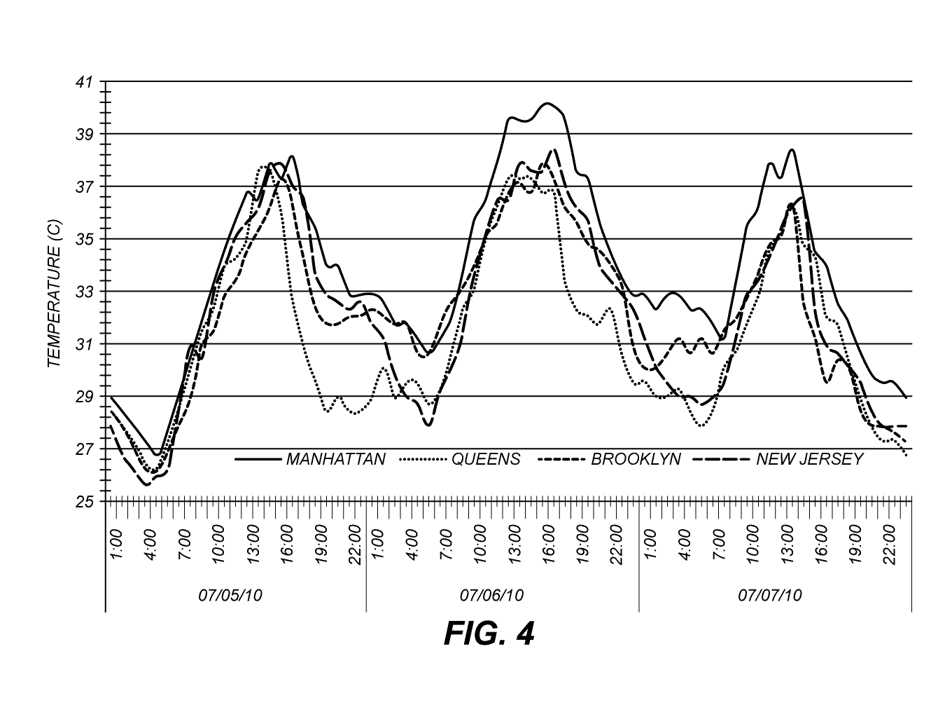

The ridge weakened and shifted westward after three days. The urban heat island produced by the highly developed urban environment over Manhattan is maintained throughout the heat wave. See FIG. 4. Despite of the evident nocturnal nature of the UHI with temperature differences of 4° C., a strong signal was registered also during the day with an UHI magnitude of 2° C. at the time when the surface temperature reached its maximum values.

### NBSD2 Assimilation Comparison

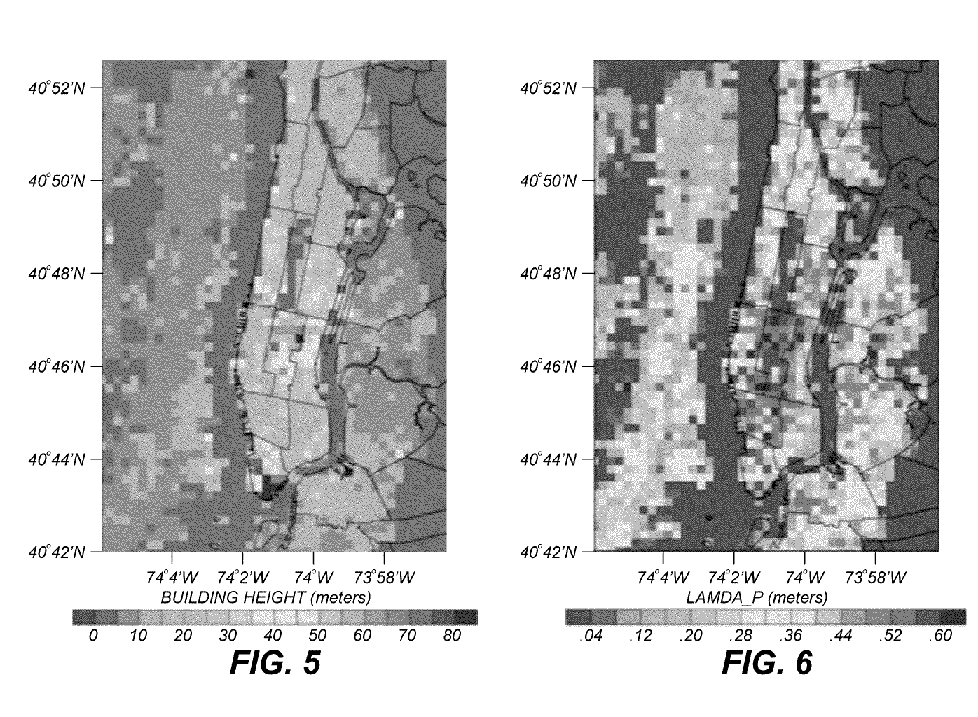

In the actual configuration of WRF, three urban classes are defined: low residential, high residential and industrial (a morphological approach). For each class, average values for the UCPs are ingested on the urban parameterization using a table. Instead of calculating the UCPs mean values corresponding to the urban classes, another approach assimilates the NBSD2 data as a grid. This technique allows a better representation of the buildings' spatial distribution with taller buildings located in Downtown and Midtown Manhattan. See FIG. 5 and FIG. 6. The morphological approach tends to overestimate UCPs values in areas like Uptown and New Jersey.

The land cover/land use classification (LCLU) is an important component to accurately represent the meteorological conditions in an urban environment. The LCLU classification available that includes the three urban classes was obtained from USGS National Land Cover Dataset (NLCD) from 2001. The criteria to categorize a region in one of the urban classes are the same for the whole country. These criteria underestimate the spatial variations in highly heterogeneous cities like New York. A new land cover/land use classification was adopted based on the distribution of the Building Plan Area Fraction. Additionally, a correction for Central Park was implemented to substitute grid points that were erroneously classified in the original classification as urban inside the park.

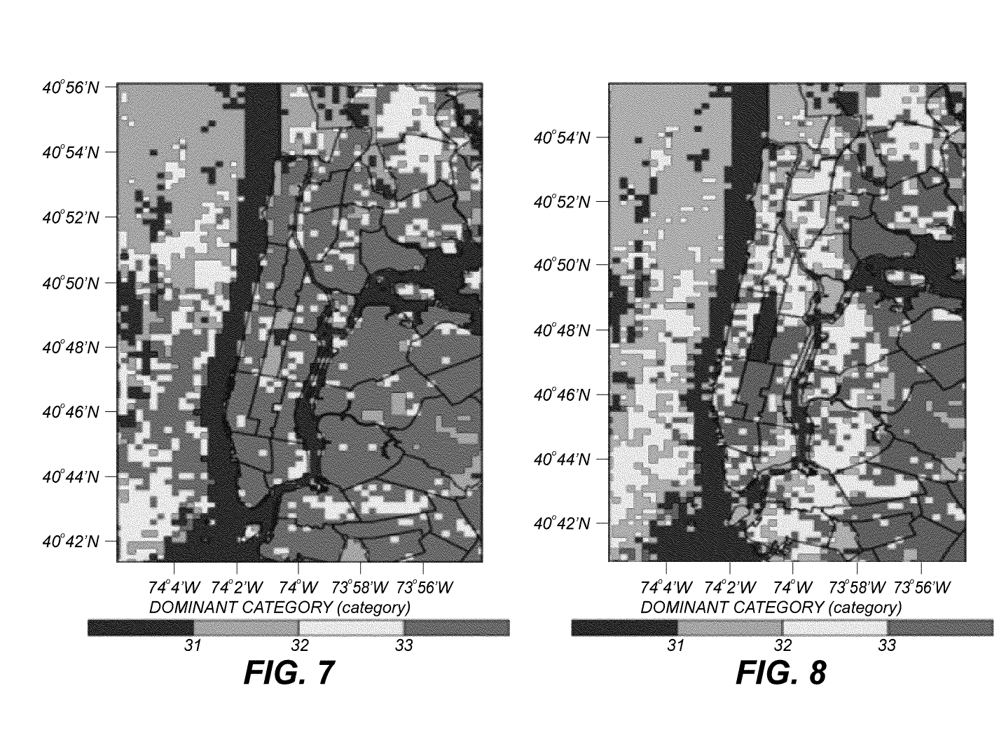

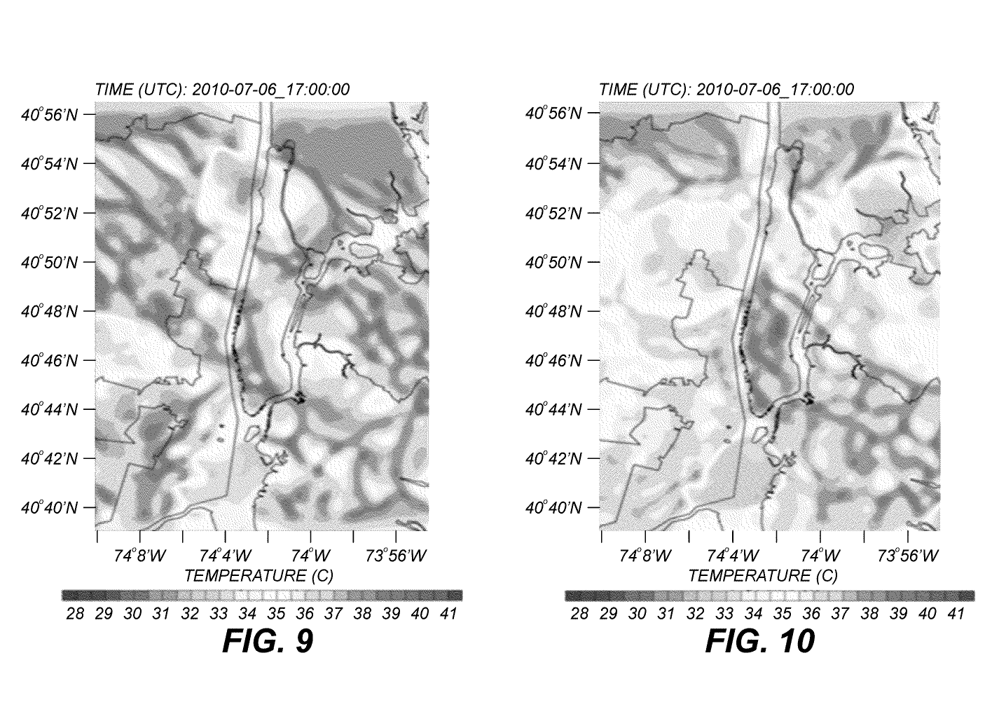

FIG. 7 and FIG. 9 shows the urban land cover distribution of the original NLCD map and the corrected one. In the corrected classification, highly dense urban areas inside Manhattan such as Midtown and Downtown are classified properly as high residential while Uptown, parts of New Jersey, Queens and Brooklyn are categorized as low residential or industrial. The regions outside the NBSD2 coverage maintained their original class which is mainly high residential.

To determine the impact on the surface temperature of the building energy model used, two simulations were performed. In the first simulation (morphological approach), average values were computed for the UCPs for each urban class, whereas in the second approach (grid approach) the urban parameters were assimilated as a grid with a resolution of 333 m. The modified land cover/land use classification was also used in the second case when spatially distributed variables like albedo and heat capacities were not available. In general, the effect of a more detailed representation of the building distribution was an increase of the surface temperature over Midtown and Downtown Manhattan and a decrease in the surrounding boroughs (FIG. 9 and FIG. 10). The table approach clearly overestimates the building characteristics over New Jersey where differences of 3° C. were registered between both simulations.

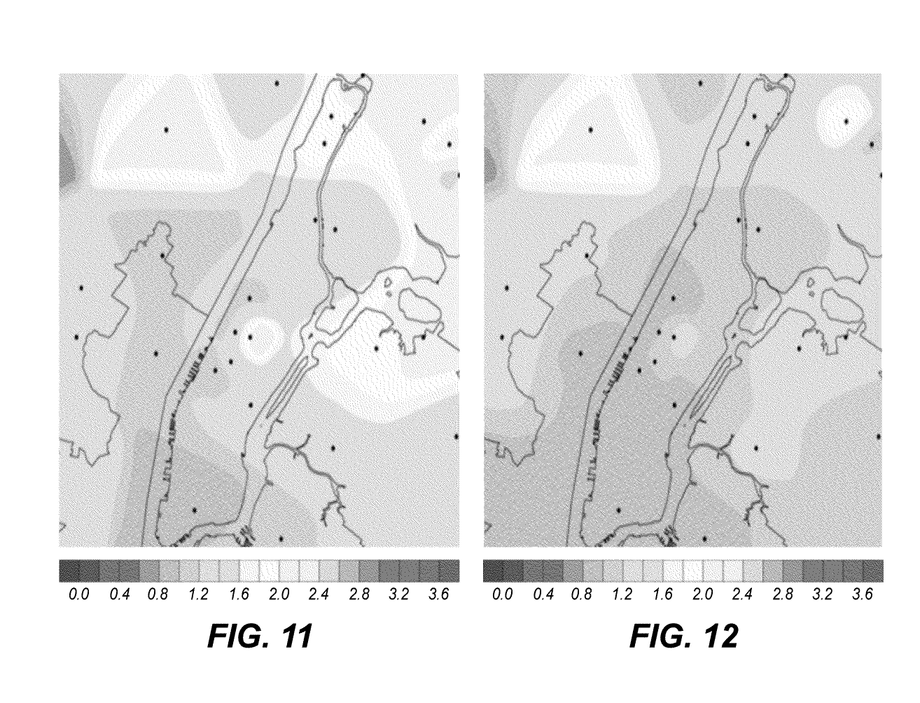

NYCMetNet's surface temperature data for Manhattan and its surroundings were compared to the results of both simulations. The Root Mean Square Error (RMSE) for a 24-h period starting on Jul. 5, 2010 at 8 PM EST was calculated (FIG. 11 and FIG. 12). FIG. 11 shows the RMSE for the urban morphological approach while FIG. 12 shows the RMSE for the grid approach. The grid approach reduces the error around the whole domain with a predominant decrease over Midtown/Downtown Manhattan, Bronx and New Jersey. The cooling effect of Central Park is underestimated in some degree by the model. However Central Park station, from an analysis with sixteen years of data, did not stand out as unusually cool compared to other urban stations around the city. The park's cool island reaches its maximum in summer nights when the neighboring urban streets are significantly warmer than the park itself.

Citywide albedo levels are known to significantly mitigate the urban heat island and reduce the consumption due to cooling. A parametric study was performed using the multilayer urban parameterization to determine the response of the surface temperature and the energy consumption to the change of the roof albedo. Two roof classes were defined. For highly reflective roofs or white roofs an albedo value of 0.8 was assigned. For dark roofs, the albedo used was 0.2.

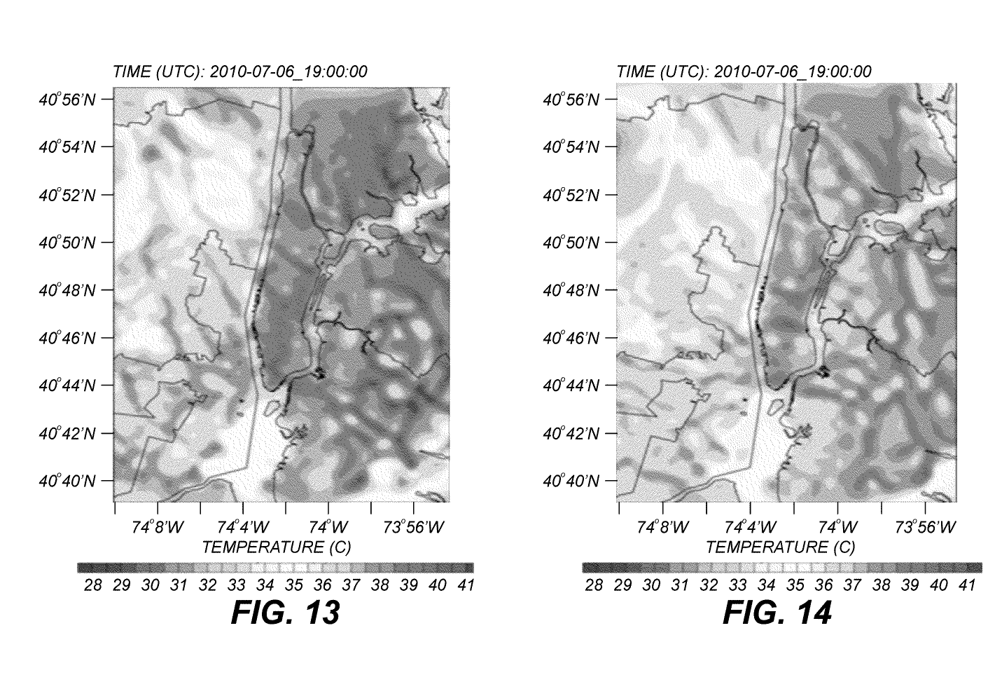

Surface temperature was reduced at least by one degree over Manhattan and its surrounding boroughs due to the increase of the roof albedo (FIG. 13 and FIG. 14).

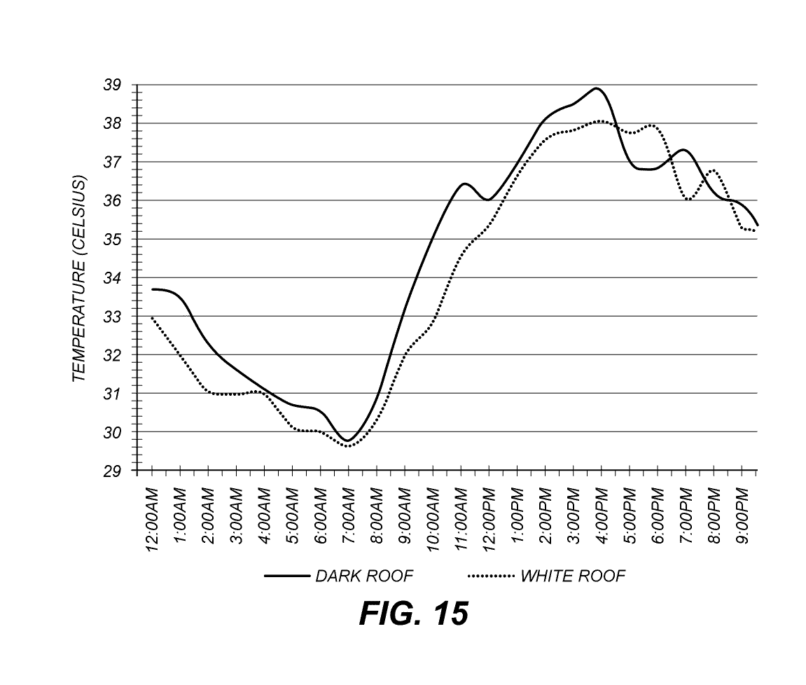

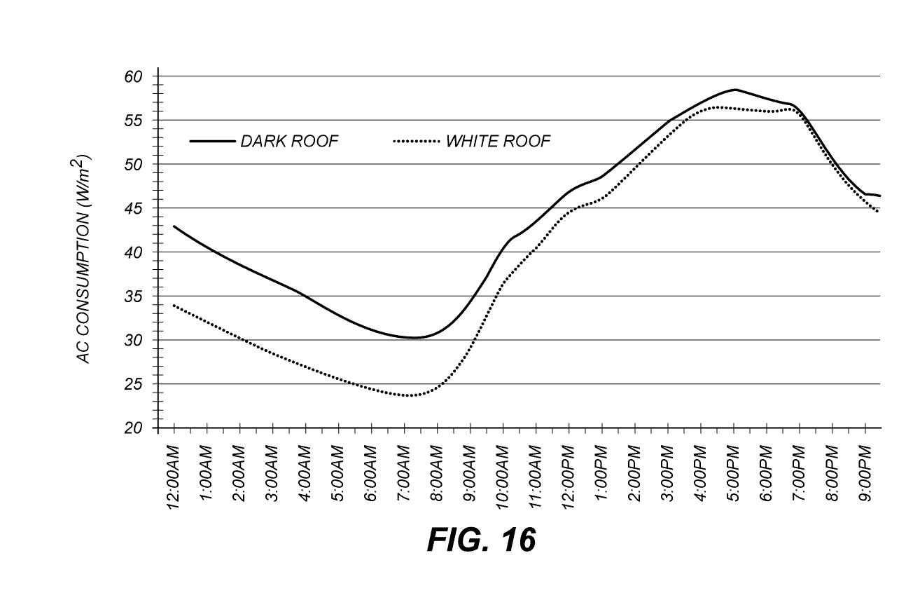

A time series analysis from a model grid cell located at Midtown Manhattan shows that the surface temperature reduction was registered for most of the 24-h period for July 6 (FIG. 15). During the day, the increase in the albedo reduced the temperature and also the amount of energy accumulated by the paved structures. As a result, less sensible heat was released and cooler temperatures were registered during the night compared to the dark roof simulations. The decrease on nighttime surface temperature due to dark and white roof hourly AC energy consumption simulations on Jul. 6, 2010 for a location in Midtown Manhattan white roofs directly affects the development of the urban heat island over NYC. See FIG. 16. On average, UHI increases rapidly in the late afternoon, remains almost constant during the night reaching temperature differences between urban and rural of 4° C. during the summer, and then decreases quickly after dawn.

### Energy Demands During Heat Wave

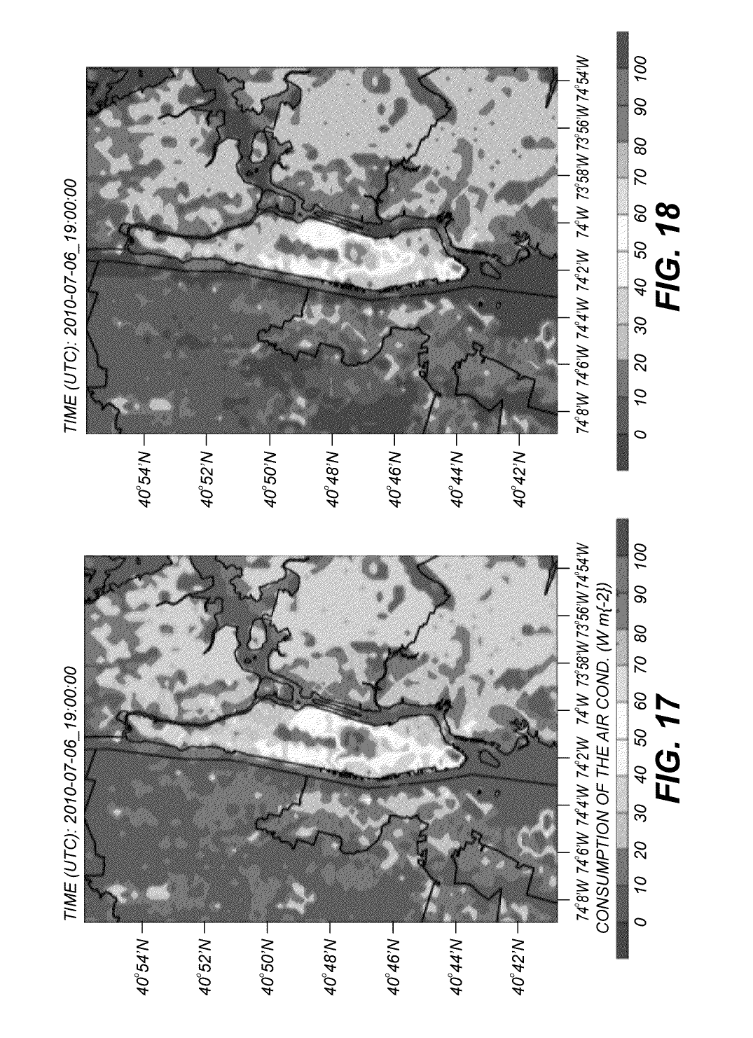

Variations in energy consumption are due to many factors such as ambient weather, building characteristics and occupancy. Occupancy (occupants per floor) and building properties like number of floors and building area are taken into account by the model to determine the energy load associated with AC systems. The target indoor temperature was set to 25° C. with a comfort range of 1° C. The A/C system operates without time restrictions. The system was activated when the outdoor temperature was warmer than indoor temperature regardless of the time of the day. For the specific case of the heat wave, this condition was met for almost the whole simulation period producing significant heat loads during nighttime. AC consumption clearly matches the building height distribution with higher values in Midtown and Downtown Manhattan where the tallest buildings are located that are classified as commercial. See FIG. 17 (dark roof) and FIG. 18 (white roof).

Consumption in the highly dense areas of the city reached about 90 W/m² at the time of the maximum temperature. This value is representative from AC consumption in commercial dwellings and consistent with empirical data for anthropogenic heat from buildings for different cities. They reported that the average hourly anthropogenic heat release for locations close to New York City (Philadelphia was the closes city reported) in the summer varies between 50 and 70 W/m² including electricity, heating fuel, transportation, and metabolism data. We expect higher values during an extreme heat event. For the same Midtown location a time series for July 6 shows the difference in energy consumption caused by the cool roofs (FIG. 16). In both cases, the consumption closely follows the daily temperature trend with maximum values in the afternoon and minimums at the early morning. The albedo has a bigger impact after midnight when the consumption difference between cases reaches about 7 W/m² and remains almost constant until dawn. In peak electricity load hours, reductions are limited to less than 5%. Individual mitigation strategies are known to produce small reductions (<1%) in peak hours and the influence of vegetation on urban climate is more important than the influence of the albedo of built surfaces.

A mesoscale analysis of the surface temperature and energy consumption distribution associated with a heat wave around New York City was presented using numerical simulations from WRF coupled with a new multilayer urban parameterization. Spatially distributed urban canopy parameters reduce the error in the simulation of the surface temperature in highly heterogeneous cities. However, for areas where these kinds of data are not available, average values still give a reasonable estimation of the city's morphology that allows the use of the multilayer urban parameterization.

Highly reflective roofs tended to decrease the surface temperature over the region which produced a reduction in the energy consumption. The effect of cool roofs is magnified during nighttime when the urban heat island reaches its maximum. Future simulations will explore the impact on the UM and energy load of mitigation strategies involving vegetation compared to high-albedo surfaces.

In some embodiments, the method includes improved surface temperature simulations through bias corrected assimilations of surface weather data from NYCMetNet stations. An improvement of the temperature simulation gives a better estimate of the energy consumption around the city. The method may also evaluate AC consumption simulations using energy data from the local energy company for specific locations in a city.

In view of the foregoing, embodiments of the disclosed method provide a more accurate estimation of predetermined energy consumption rates for urban environments. A technical effect is to permit utility companies to adjust energy production to satisfy a predetermined demand.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a non-transient computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for forecasting energy demand for a building in an urban environment, the method comprising steps of:
determining a predicted weather condition of an urban environment at a predetermined time using a weather forecasting model;
finding, using a building energy model, an impact of the predicted weather condition on an urban heat island (UHI) of the urban environment, the step of finding producing a weather-adjusted UHI condition;
quantifying a predicted energy consumption rate for a building in the urban environment at the predetermined time based on the weather-adjusted UHI condition that incorporates the impact of the predicted weather condition on the urban heat island (UHI).

2. The method as recited in claim 1, wherein the method forecasts the energy consumption rate over a time frame, wherein the predetermined time is within the time frame.

3. The method as recited in claim 1, wherein the building energy model segments the urban environment into uniform grids.

4. The method as recited in claim 1, wherein the building energy model segments the urban environment into uniform grids with a grid size, the grid size selected to group buildings with a uniform horizontal distribution together.

5. The method as recited in claim 1, wherein the building energy model segments the urban environment into uniform grids with a grid size, the grid size selected to group buildings with a uniform mean building height together.

6. The method as recited in claim 1, wherein the building energy model segments the urban environment into uniform grids with a grid size, the grid size selected to group buildings with dark roofs together.

7. The method as recited in claim 6, wherein the building energy model segments the urban environment into uniform grids with a grid size, the grid size selected to group buildings with white roofs together.

8. The method as recited in claim 1, further comprising presenting results of the step of quantifying in units of energy consumption per unit time.

9. The method as recited in claim 1, wherein the building energy model comprises a Building Energy Parameterization (BEP) that accounts for thermal impacts from horizontal and vertical building surfaces of the building.

10. The method as recited in claim 1, wherein the building energy model comprises a Building Energy Model (BEM) that accounts for consumption of energy due to air conditioning (AC) systems.

11. The method as recited in claim 10, wherein the Building Energy Model (BEM) accounts for generation of heat due to the air conditioning (AC) systems.

12. The method as recited in claim 11, wherein the Building Energy Model (BEM) accounts for diffusion of heat through walls, roofs and floors.

13. A method for forecasting energy demand for a plurality of building in an urban environment, the method comprising steps of:
determining a predicted weather condition of an urban environment at a predetermined time using a weather forecasting model;
modifying the predicted weather condition using a building energy model that incorporates an impact of an urban heat island (UHI) of the urban environment on the predicted weather condition, the step of modifying producing a predicted local condition; wherein the building energy model segments the urban environment into uniform grids wherein at least 20% of buildings within at least one uniform grid have a height greater than ten meters;
quantifying a predicted energy consumption rate for a plurality of buildings in the urban environment at the predetermined time based on the predicted local condition that incorporates the impact of the urban heat island (UHI) on the predicted weather condition.

14. The method as recited in claim 13, further comprising presenting results of the step of quantifying in units of energy consumption per unit area.

15. A method for forecasting energy demand for a plurality of building in an urban environment, the method comprising steps of:
determining a predicted weather condition of an urban environment over a predetermined time frame using a weather forecasting model;
modifying the predicted weather condition using a building energy model that incorporates an impact of an urban heat island (UHI) of the urban environment on the predicted weather condition, the step of modifying producing a predicted local condition; wherein the building energy model segments the urban environment into uniform grids wherein at least 20% of buildings within at least one uniform grid have a height greater than ten meters;
quantifying a predicted energy consumption rate for a plurality of buildings in the urban environment over the predetermined time frame based on the predicted local condition that incorporates the impact of the urban heat island (UHI) on the predicted weather condition.

16. The method as recited in claim 15, further comprising presenting results of the step of quantifying in units of energy consumption per unit area.

17. The method as recited in claim 15, wherein at least 40% of buildings within the at least one uniform grid have a height greater than ten meters.
